(19) United States
(12) Patent Application Publication
(10) Pub. No.: US 2002/0113349 A1
(43) Pub. Date: Aug. 22, 2002

(54) Nonlinear and adjustable bushings

(76) Inventor: Evgeny I. Rivin, West Bloomfield, MI (US)

Correspondence Address: Evgeny I. Rivin, 4227 Foxpointe Dr., West Bloomfield, MI, 48323, US

(21) Appl. No.: 10/073,399

(22) Filed: Feb. 11, 2002

Related U.S. Application Data
(60) Provisional application No. 60/267,548, filed on Feb. 9, 2001.

(51) Int. Cl. F16M 9/00

(52) U.S. Cl. 267/140.2; 267/140.3

(57) ABSTRACT

A bushing for connecting mechanical components while providing a limited mobility between them has rubber elastic elements of streamlined shapes (cylinder, sphere, torus, etc.) thus having nonlinear load deflection characteristics in several coordinate directions and provides for adjustability of stiffness constants in various directions if adjusting means are built in.

Priority for this application is requested to be Feb. 9, 2001 per Provisional Patent Application No. 60/267,548.

### FIELD OF THE INVENTION

The present invention relates to elements for connecting mechanical components while providing for limited displacements between them.

### BACKGROUND OF THE INVENTION

Mechanical components often need to be connected in such a way that their general relative disposition is reliably defined while they have relative mobility in one or more translational and/or angular directions. Some examples include automotive steering and suspension systems which comprise linkages connected with rubber bushings; vibration isolating mounts, e.g. between a jet engine and the wing on which it is mounted or between a surface vehicle engine and the vehicle underbody. In many cases these vibration isolating mounts are also embodied as bushings.

A bushing is usually designed as an assembly containing coaxial inner and outer sleeves made from metal or from another rigid material (e.g., hard plastic) and a coaxial rubber layer (insert) between said outer and inner sleeves. The rubber insert can be connected to the outer and inner sleeves by bonding or by a mechanical attachment (e.g., by interference fit). A typical prior art rubber bushing is shown in FIG. 1 (cross sectional view) and FIG. 2 (plane view). In both FIGURES two modifications of the prior art bushings are shown, one represented by the left sides of the drawings, the other represented by the right sides of the drawings. The inner and the outer sleeves of the bushings are attached, respectively, to the first and second mechanical components being connected.

The rubber insert generally provides various degrees of mobility between the connected mechanical components in three translational and three angular coordinate directions. Mobility in each direction can be characterized by translational and angular stiffness constants. In many applications the degree of the relative mobility between the connected components, at least in some coordinate directions, is influencing performance characteristics of the device in which the bushing(s) are employed (vehicle, aircraft, etc.). Accordingly, it is often beneficial to select magnitudes of the stiffness constants at least in some coordinate directions so that performance characteristics of the device are improved or optimized. Since usually the mechanical systems (such as steering or braking linkage systems, vibration isolation systems) are very complicated, they cannot be optimized analytically or computationally. A typical optimization or “tuning” procedure involves fabricating a variety of rubber bushings having different parameters (stiffness constants in various directions), and testing/measuring the relevant performance characteristics of the device equipped with different bushings taken from this variety. Obviously, such a procedure is expensive due to costs of custom fabrication of the multitude of different bushings and labor costs for installation and replacement of each set of bushings. It is also very time consuming due to the need of disassembly/assembly of the whole unit for changing the bushing(s). But with all these money and time costs, still the optimal combination of parameters is often can not be found since the variety of bushing parameters for the testing is limited and the optimal combination can be missed.

The prior art bushings are usually characterized by certain values of the stiffness constants in each translational and/or angular direction. Variation of load magnitudes along various coordinate directions usually does not significantly change the stiffness constants. On the other hand, there are numerous circumstances wherein nonlinear characteristics at least in some directions of loading would be beneficial. With a nonlinear load-deflection characteristic, the stiffness is no longer constant but is changing with the changing load.

### SUMMARY OF THE INVENTION

The present invention addresses the inadequacies of the prior art by providing a bushing whose stiffness and other performance characteristics can be changed without a need for fabricating a new bushing, just by changing preloading conditions of plurality of nonlinear rubber elements represented by so-called streamlined rubber elements. In this Specification, the term “streamlined rubber element” means radially loaded cylinder of round or elliptical cross section, toruse/O-ring, sphere, ellipsoid, and similarly shaped rubber elements demonstrating low stress concentration under compression.

The present invention further improves on the prior art by providing a bushing whose stiffness and other performance characteristics can be changed differently in different coordinate directions without a need for fabricating a new bushing, by a selective preloading to a different degree of compression of various constitutive nonlinear streamlined rubber elements.

The present invention improves and simplifies the tuning process for bushings used for connecting linkages, vibration isolators, or other applications by providing means for selective changing of performance characteristics of the bushings while they are assembled or otherwise installed at their permanent locations without a need for labor intensive and time consuming disassembly and reassembly of the whole unit.

The present invention further improves the tuning process for bushings by providing for gradual change of their stiffness constants in the required coordinate directions during the tuning process.

The bushings constructed in accordance with the present invention can have nonlinear load-deflection characteristics found beneficial for various applications.

### BRIEF DESCRIPTION OF THE DRAWINGS

The present invention can be best understood with reference to the following detailed description and drawings, in which:

FIG. 1 is an axial cross section of two embodiments of conventional rubber bushings with solid rubber inserts;

FIG. 2 is the top view of bushings in FIG. 1;

FIG. 3 is an axial cross section of one embodiment of the proposed invention wherein rubber inserts accommodating radial loads are rubber cylinders deforming in radial compression in the direction of the applied load;

FIG. 4 is a radial cross section of bushing in FIG. 3 wherein the rubber cylinders are assembled into the bushing without preload;

FIG. 5 is a load deflection characteristic of a radially compressed rubber cylinder;

FIG. 6 is a radial cross section of bushing in FIG. 3 wherein the rubber cylinders are assembled into the bushing with radial preload;

FIG. 7 is an axial cross section of another embodiment of the proposed invention wherein rubber elements accommodating radial loads are rubber spheres accommodating the radial loads applied to the bushing by radial compression in the direction of the applied load, and accommodating axial loads applied to the bushing by radial compression of a set of two rubber cylinders with preloading means for the latter;

FIG. 8 is a radial cross section of bushing in FIG. 7 wherein the rubber spheres are assembled into the bushing without preload;

FIG. 9 is a side view of bushing in FIGS. 7, 8;

FIG. 10 is the radial cross section of bushing in FIG. 11 which represents yet another embodiment of the proposed invention wherein the rubber inserts can be selectively preloaded in desirable radial directions while the bushing is mounted in the mechanical device;

FIG. 11 is an axial cross section of the bushing in FIG. 10 showing axial preload means and uninterrupted radial preloading shoes;

FIG. 12 is an axial cross section of another modification of the bushing in FIG. 10 showing axial preload means and segmented radial preloading shoes.

### DETAILED DESCRIPTION OF THE PREFERRED EMBODIMENTS

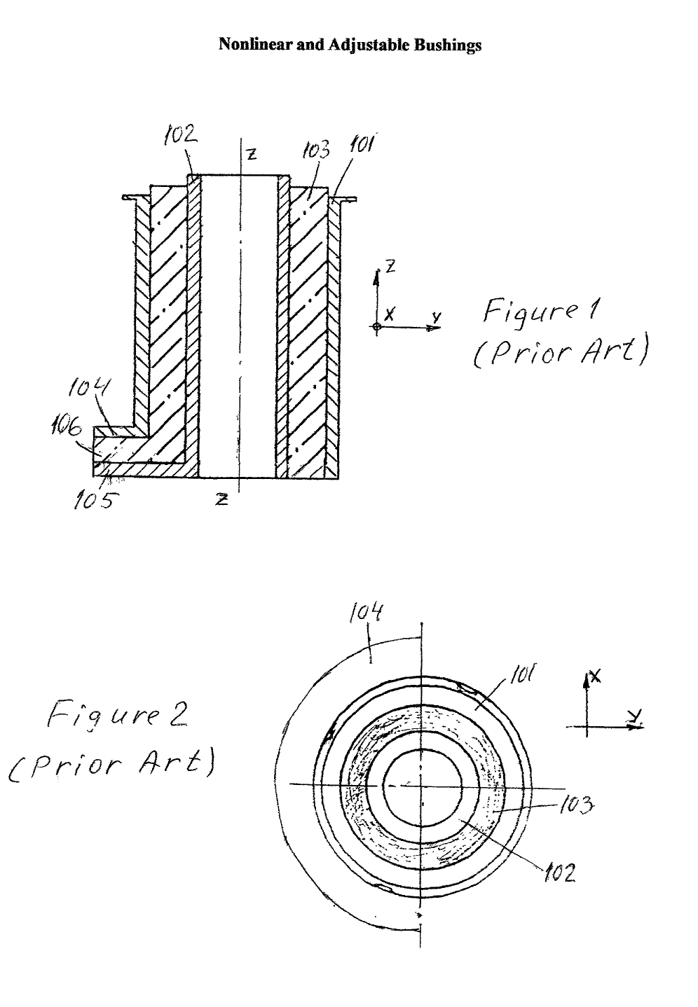

FIGS. 1 and 2 depict two modifications of typical conventional bushings for automotive linkages (Prior Art). The left halves of FIGS. 1 and 2 show a bushing in which the rubber insert is loaded in compression in both radial (x and y) and axial (z) directions, while the right halves of FIGS. 1 and 2 show a bushing whose stiffness in z direction is due to shear of the rubber insert. Outer 101 and inner 102 sleeves made from metal or other hard material are attached to the appropriate connected links (not shown); rubber sleeve (insert) 103 is either molded within the space between sleeves 101 and 102 and bonded to them or is fabricated separately and inserted into space between 101 and 102 and assembled by interference fit, e.g. by swaging outer sleeve 101. The left side modification is also characterized by collars 104 and 105 on outer 101, inner 102 sleeves, respectfully, and by radial extension 106 of rubber insert 103. This prior art bushing has certain stiffness constants in two principal radial directions, stiffness constant in the axial direction, and two principal “cardan” stiffness constants (angular stiffness in the planes containing axis of the bushing). Two principal radial (x and y) and two principal cardan (in planes x-z and y-z) stiffness constants are identical between themselves for the bushing in FIGS. 1 and 2, although there exist designs having anisotropy between x-z and y-z planes (e.g., by designing cavities/voids in the rubber element at the respective orientations). For any modification, all stiffness constants are characteristic for a given coupling and cannot be changed without replacing the whole bushing assembly. It is obvious that this bushing can be used not only for connecting links but also for interfacing any mechanical components, e.g. can serve as a vibration isolator.

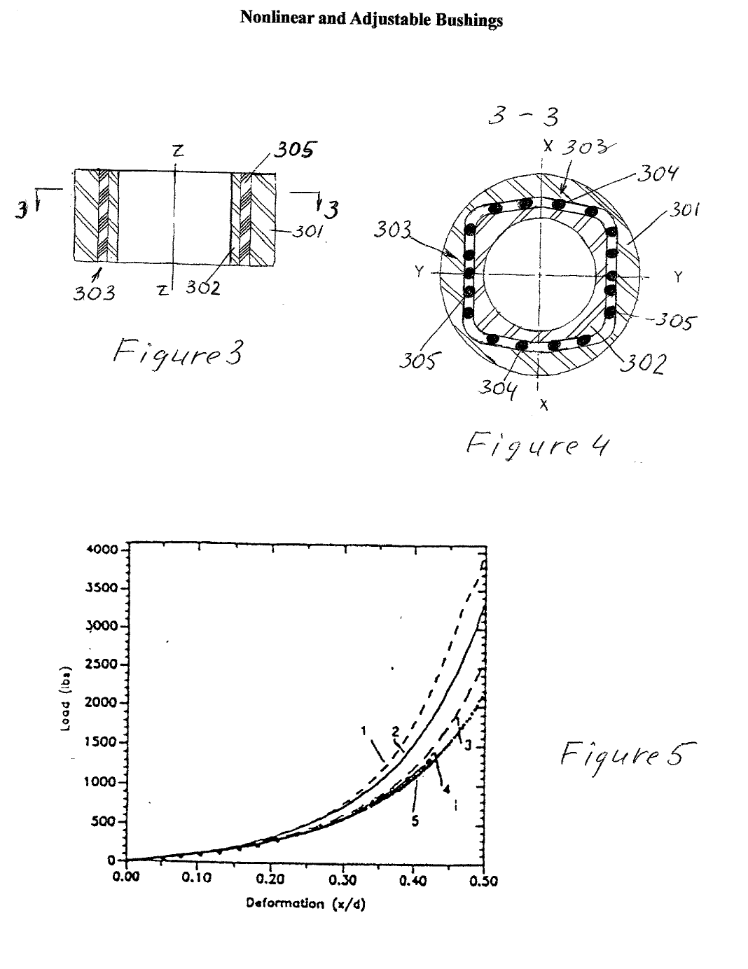

FIG. 3 shows an axial cross section of one embodiment of the proposed nonlinear bushing. Outer sleeve 301 and inner sleeve 302 are separated by rubber inserts 303 comprising a plurality of rubber cylinders 304 and 305 whose cross sections are seen in FIG. 4. The specified positioning/packaging of rubber elements can be maintained by gluing (tacking) them to at least one of the rigid surfaces (internal surface of outer sleeve 301 and/or external surface of inner sleeve 302), or by connecting them together by thin connecting membranes or bridges (not shown), or by filling gaps between the cylinders with soft foam or other soft matrix not significantly modifying their deformation characteristics (not shown).

The embodiment in FIGS. 3, 4 is different from the prior art FIGS. 1, 2 in several respects. Two of the important differences are the following. First of all, deformation characteristics of the bushing in FIGS. 3, 4 in x and y directions can be made different by using different diameter/lengths rubber cylinders 304 in x direction and 305 in y direction, and/or by using different rubber blends in x and y directions, and/or by using different number of rubber cylinders in x and y directions. Secondly, the load-deflection characteristic of rubber cylinders during radial compression is nonlinear with stiffness increasing with the increasing radial compression force.

FIG. 5 shows load-deflection characteristics of rubber cylinder having diameter d=0.87 in and length L=4.0 in (relative compression x/d vs. load, where x is radial deformation) for different conditions: 1—between sandpaper-covered surfaces; 2—between steel nonlubricated surfaces; 3—between lubricated surfaces; 4-cylinder embedded into foam; 5—cylinder cut in four pieces 1.0 in long each. (FIG. 5 is taken from Rivin, E. I., Lee, B. S., “Experimental Study of Load-Deflection and Creep Characteristics of Compressed Rubber Components for Vibration Control Devices”, ASME Journal of Mechanical Design, 1994, Vol. 116, pp. 539-549). It is apparent from FIG. 5 that stiffness is increasing at least ten-fold with increasing compression deformation from x/d=0 to x/d=0.5.

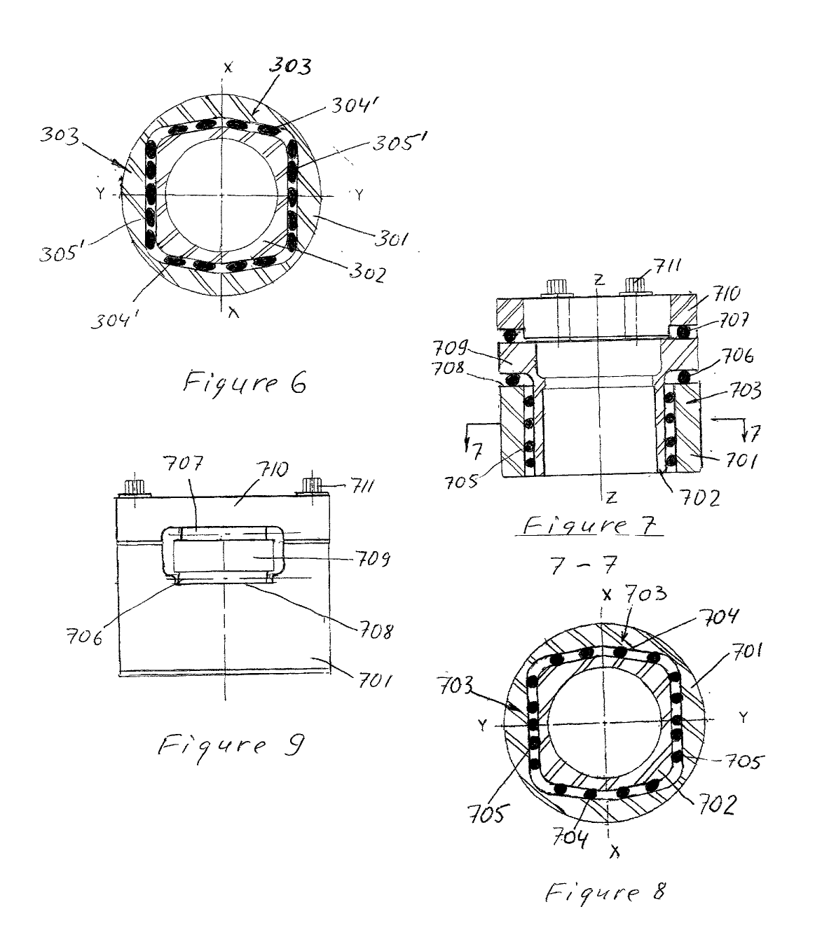

The nonlinear stiffness of bushing in FIGS. 3, 4 can be useful, e.g. for providing good isolation of high-frequency vibration from the road to the interior of the vehicle during straight ride (small loads, small deformations/vibration amplitudes, and low stiffness desirable for vibration isolation), while providing good handling for steering and/or braking maneuvers (large forces and deformations, high stiffness desirable for good handling). However, in some cases a constant but adjustable stiffness in x and/or y directions is desirable. This can be realized in bushing in FIG. 3 with rubber cylinder diameters larger than the space between outer 301 and inner 302 sleeves, as shown in cross section in FIG. 6. Rubber cylinders 304′ and 305′ in FIG. 6 are precompressed (preloaded) even before any external radial forces are applied to the bushing. The radial stiffness of the bushing in the x direction K_{bush}_{ₓ} is in this case

K_{bush}_{ₓ}=2nk₁(x/d), (1)

where k₁(x/d) is stiffness of one rubber cylinder precompressed to relative compression x/d and determined from a plot similar to ones in FIG. 5 but determined for the actual rubber cylinder employed in the bushing in x direction, and n is the number of rubber cylinders loaded in x direction on one side of the bushing. Thus, by inserting rubber cylinders preloaded to various degrees of precompression, stiffness of the bushing in the desirable radial direction can be changed in a broad range.

Insertion of the precompressed rubber cylinders into the space between outer 301 and inner 302 sleeves in FIGS. 3, 6 can be done in various ways. The preferred way is by deforming cylinders to the required precompression outside of the bushing (e.g., by a mechanical press) and cooling the deformed rubber cylinder below its “glass transition” temperature wherein the deformed cylinder is solidified and can be easily inserted into the appropriately dimensioned space between outer and inner sleeves 301, 302. The rubber cylinders can be used “as is” or attached to rigid (e.g., metal) face plates (not shown).

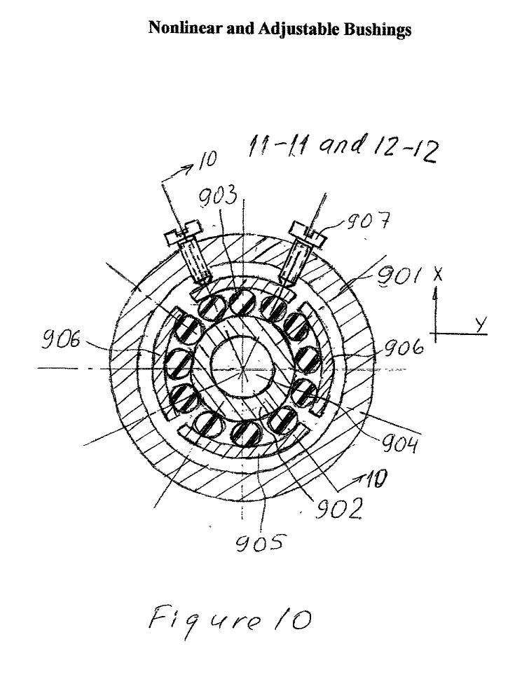

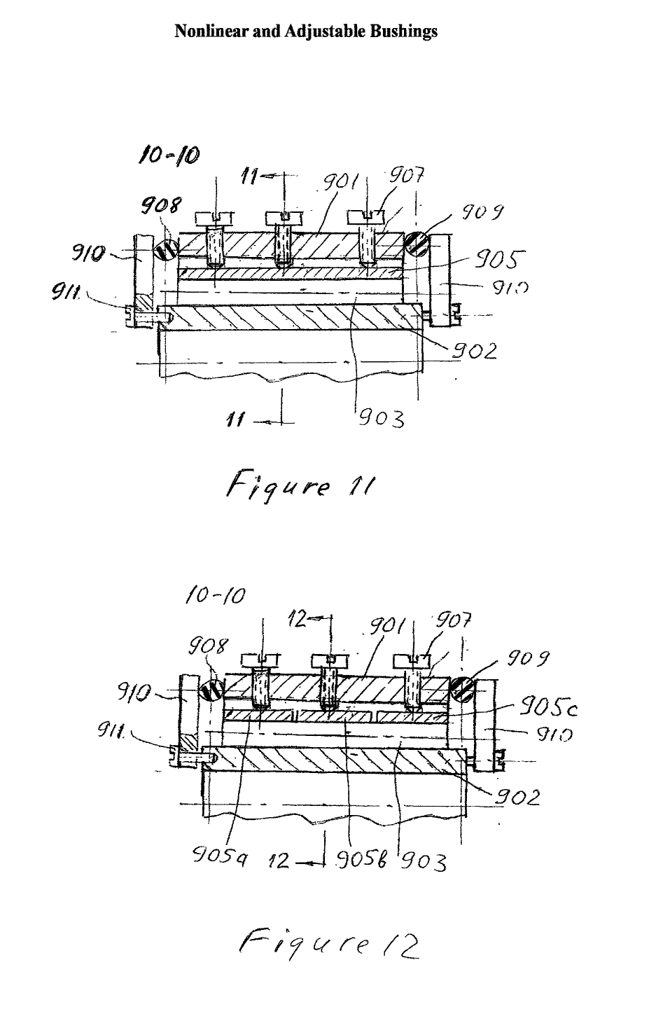

FIGS. 7, 8, 9 show another embodiment of the proposed bushing wherein the rubber insert 703 between outer sleeve 701 and inner sleeve 702 comprises strings of rubber spheres 704 accommodating radial loads in x direction and rubber spheres 705 accommodating radial loads in y direction. This bushing also has nonlinear/adjustable stiffness in axial (z) direction determined by rubber cylinders 706, 707. Rubber cylinders 706 are placed between face 708 of outer sleeve 701 and collar 709 of inner sleeve 702, and rubber cylinders 708 are placed between collar 709 and holding plate 710. Holding plate (preloading shoe) 710 is attached to outer sleeve 701 by bolts 711.

Rubber spheres 704, 705 are shown as not precompressed in FIGS. 7, 8, but obviously they can be precompressed similarly to rubber cylinders as discussed above in relation to FIGS. 3 and 6. Rubber spheres (or ellipsoids) can be used, rather than the rubber cylinders, when lower stiffness of the bushing is required, at least in one direction x or y. The specified positioning/packaging of rubber spheres can be maintained by the same techniques as described above, namely by gluing (tacking) them to at least one of the rigid surfaces, or by connecting them together by thin connecting membranes or bridges (not shown), or by filling gaps between the spheres with soft foam or other soft matrix not significantly modifying their deformation characteristics (not shown).

Rubber cylinders 706, 707 determine axial (z direction) stiffness of the bushing. If these cylinders are not preloaded in compression by tightening bolts 711, the load deflection characteristic of the bushing in z direction is nonlinear, similar to plots in FIG. 5. It can be modified/adjusted by a measured tightening of bolts 711 thus creating variable but constant stiffniess as described in expression (1) above, where “x” is replaced by “z”. When a specified magnitude of the axial stiffness is required, corresponding to a known precompression, bolts 711 can be replaced by known unadjustable fastening means (e.g., rivets). If a low axial stiffness is required, then rubber cylinders 706, 707 can also be replaced by rubber spheres or ellipsoids as it is shown in FIGS. 7, 8 for radial x and y directions.

Embodiment of the proposed bushing shown in FIGS. 10, 11 allows adjusting (tuning) of stiffniess constants in three translational coordinate directions x, y and z while the bushing is installed into the device it is servicing, e.g. into a steering or braking linkage. This bushing has coaxial outer sleeve 901 and inner sleeve 902 having, when assembled, an annual space between them. This space houses streamlined rubber elements 903 accommodating radial load in x direction and 904 accommodating radial load in y direction (cylinders are shown in FIGS. 10 and 11, but spheres, ellipsoids, etc. can be used). Group of rubber elements accommodating radial load in one radial coordinate direction, is combined with preload-application shoes 905 (for x direction) or 906 (for y direction). These shoes can be pushed or retracted in the radial direction thus changing precompression of the respective group of rubber elements and thus changing stiffness in this direction. Various means can be used for pushing/retracting the shoes. Set screws 907 are shown for one shoe in FIG. 10, but other techniques including hydraulic, electric, piezo, etc. actuators can be used. Actuating devices for other shoes are not shown in FIG. 10.

The bushing in FIGS. 10 and 11 also comprises means for adjusting/tuning axial (z) stiffniess; rubber O-rings 908 and 909 are placed between preloading shoes 910 and outer sleeve 901, and preloading shoes 910 are adjustably attached by bolts 911 to inner sleeve 902. Thus, axial stiffness of the bushing is determined by axial stiffness of O-rings 908 and 909 and by usually much lower axial (shear) stiffness of rubber elements 903 and 904. Since axial load-deflection characteristic of O-rings 908 and 909 are similar to the plots shown in FIG. 5, tightening/loosening of adjusting bolts 911 results in changing axial stiffiess of the bushing in a broad range.

FIG. 12 gives a modification of the embodiment in FIGS. 10, 11 wherein each preload-application shoe 905 and/or 906 is divided into several segments (three segments 905a, 905b, 905c for y direction are shown in FIG. 12). With such configuration, each segment can be adjusted individually and combination of the degree of their adjustment (tightening or loosening) results in changes in both radial and cardan stiffness in the plane of the drawing. For example, if shoes 905a and 905c are tightened, but not 905b, then the cardan stiffness would increase about as much but the radial stiffness would increase not as much as if compared with uniform tightening of all three shoes.

It is readily apparent that the components of nonlinear and adjustable bushings disclosed herein may take a variety of configurations. Thus, the embodiments and exemplifications shown and described herein are meant for illustrative purposes only and are not intended to limit the scope of the present invention, the true scope of which is limited solely by the claims appended thereto.

1. A bushing for mechanically connecting two mechanical components so that to allow specified relative motions along at least one translational and/or angular coordinate, comprising:
outer sleeve;
inner sleeve inserted into said outer sleeve;
rubber insert disposed between said outer and inner sleeves;
said rubber insert comprising a plurality of streamlined rubber elements

2. The bushing of claim 1 wherein at least one of said streamlined rubber elements is preloaded in compression

3. The bushing of claim 1 wherein at least one subset of said plurality of streamlined rubber elements is integrated into at least one specified package by means not affecting compression characteristics of said streamlined rubber elements

4. The bushing of claim 3 wherein said means constitute tacking of said elements to the outer sleeve

5. The bushing of claim 3 wherein said means constitute thin membranes attached to said elements

6. The bushing of claim 3 wherein said means constitute embedding said elements into soft foam matrix

7. The bushing of claim 2 wherein said preloaded rubber elements are precompressed and frozen below their glass transition temperature before the insertion

8. A bushing for mechanically connecting two mechanical components so that to allow specified relative motions along at least one translational and/or angular coordinate, comprising:
outer sleeve;
inner sleeve inserted into said outer sleeve;
preload-application shoes disposed between said outer and inner sleeves;
compression load actuators disposed between said outer sleeve and said preload-application shoes
rubber insert disposed between said preload-application shoes and said inner sleeve;
said rubber insert comprising a plurality of streamlined rubber elements

9. The bushing of claim 8, wherein said preload-application shoes comprise several segments, each segment being acted upon by at least one said compression load actuator
